(19) United States
(12) Patent Application Publication
(10) Pub. No.: US 2018/0363200 A1
(43) Pub. Date: Dec. 20, 2018

(54) WALL MOUNTED WASHING MACHINE AND COVER THEREOF

(71) Applicant: DONGBU DAEWOO ELECTRONICS CORPORATION, Seoul (KR)

(72) Inventor: Jeong Hyeon GIM, Incheon (KR)

(21) Appl. No.: 15/938,160

(22) Filed: Mar. 28, 2018

(30) Foreign Application Priority Data
Jun. 14, 2017 (KR) 10-2017-0074631

(51) Int. Cl. D06F 37/26; D06F 37/20; D06F 39/00; D06F 39/08; D06F 39/14; D06F 37/10

(52) U.S. Cl. CPC D06F 37/263; D06F 37/206; D06F 39/005; D06F 39/083; F16B 43/001; D06F 37/10; D06F 39/088; D06F 37/262; D06F 39/14

(57) ABSTRACT

A wall mounted washing machine reduces operating noise and prevents impacts caused by physical contact in advance, the machine includes a cabinet having a front surface and a rear surface to be opened to form an appearance; a tub disposed in the cabinet, the tub operable to be filled with wash water; a front panel installed in the tub; a drum rotatably installed in the tub; a cover installed in the front panel and having a door hinge; and a door rotatably coupled to the door hinge and having a door inner frame and a door outer frame coupled to each other. The cover includes a gap holding portion integrally formed on a lower outer surface of the cover to prevent interference between a lower outer surface of the door inner frame and a lower outer surface of the cover which face each other.

### CROSS REFERENCE TO RELATED PATENT APPLICATION

The present disclosure claims benefit to Korean Patent Application No. 10-2017-0074631, filed on, Jun. 14, 2017, by inventor Gim Jeong Hyeon, which application is hereby incorporated by reference for all purposes.

### TECHNICAL FIELD

The present disclosure relates to a wall mounted washing machine and a cover thereof.

### BACKGROUND

A washing machine is a device for separating contaminants from washed fabric (laundry) using wash water and detergent, wherein the contaminants may be separated from the washed fabric by the chemical action of the detergent dissolved in the wash water and the mechanical action of the wash water and an inner basket. Such washing machines may be categorized into a top loading type washing machine, a front loading type washing machine, and a combined type washing machine combined with the top loading type and the front loading type, depending on the method of loading the laundry.

In recent years, wall mounted washing machines have been introduced, which may be installed in narrow spaces such as bathrooms and toilets. In general, the wall mounted washing machines employ the front loading type for better miniaturization.

For example, the wall mounted washing machine may include a cabinet that forms an exterior, a tub provided in the cabinet filled with wash water, a drum rotatably installed in the tub and accommodating the laundry, a drive unit providing power to the drum, a water supply unit for supplying the wash water to the tub, and a drain unit for discharging the wash water from the tub to the outside of the cabinet

A conventional wall mounted washing machine has a separate knob or handle for opening and closing the door with added force, which can make opening and closing the door fairly inconvenient for the user when done in repetitive fashion. In addition, due to the repetitive load pulling on the door, there is a risk of damage to the knob or handle.

Further, some conventional wall mounted washing machines provide means or mechanims for automatically or semi-automatically opening and closing the door. However, it is very difficult to secure a space within the washing machine for installing these types of door opening/closing devices.

### SUMMARY

In view of the foregoing, embodiments of the present disclosure provide a wall mounted washing machine and a cover thereof, wherein door opening operations may be easily performed by providing an electronic door opening and closing device. Using such a device, locking release actions of a door locking unit and door opening actions may be performed by simply pressing a door opening button, and furthermore, in accordance with embodiments of the present invention, interference between the door and the cover may be prevented when the door is operated.

Embodiments of the present invention are drawn to a wall mounted washing machine comprising: a cabinet having a front surface and a rear surface; a tub disposed in the cabinet and operable to contain wash water; a front panel disposed in the tub; a drum rotatably installed in the tub; a cover disposed in the front panel and comprising a door hinge; and a door rotatably coupled to the door hinge and comprising a door inner frame and a door outer frame which are coupled to each other, and wherein the cover comprises: a gap holding portion integrally formed on a lower outer surface of the cover and operable to prevent physical interference between a lower outer surface of the door inner frame and a lower outer surface of the cover which face each other. Embodiments include the above and wherein the door further comprises: a door glass supported by an open center side edge of the door inner frame; a protective glass disposed on a front surface of the door outer frame within a center opening of the door outer frame; a circuit receiving portion protruding from an inner surface of the door outer frame toward the door inner frame with respect to a lower position of the center opening and wherein said circuit receiving portion accommodates a display circuit; and a circuit protection portion integrally formed on the door inner frame to protrude from a lower outer surface of the door inner frame toward the cover, and shaped to correspond with a shape of the circuit receiving portion, and wherein the circuit protection portion of the door maintains a gap with respect to the gap holding portion of the cover when the door is closed.

Embodiments include the above and wherein the gap holding portion is recessed toward the front panel. Embodiments include the above and wherein the circuit receiving portion comprises: a wall body that protrudes from an inner surface of the door outer frame in correspondence with an outer side of the display circuit and is open in a front-rear direction to accommodate the display circuit; and a screw support disposed on both sides of the wall body and integrally formed on the inner surface of the door outer frame. Embodiments include the above and wherein the circuit protection portion comprises a screw hole formed in the circuit protection portion and operable to fasten a screw corresponding to the screw support. Embodiments include the above and wherein the screw hole of the circuit protection portion has a seating groove formed at an end thereof and is operable to project a head portion of the screw to an outer surface of the circuit protection portion. Embodiments include the above and wherein an outer surface of the door inner frame comprises a ring-shaped protrusion operable to support an edge portion of the door glass.

Embodiments include the above and wherein the cover comprises: a cover inclined plane formed between a laundry inlet of the cover and an outer rim of the cover to not contact an outer surface of the door inner frame, and wherein the cover inclined plane extends along a circumferential direction of the cover. Embodiments include the above and wherein the cover inclined plane comprises: a lower inclined plane extending in a radial direction of the cover from the laundry inlet and operable to maintain a gap with respect to the ring-shaped protrusion of the door inner frame; an upper inclined plane integrally formed with an outer edge of the lower inclined plane and extending at a relatively larger inclination angle than the lower inclined plane; and a channel portion integrally formed with an outer edge of the upper inclined plane and coupled with a cover connection unit of the cabinet.

Embodiments of the present invention are drawn to a washing machine comprising: a cabinet; a tub disposed in the cabinet and operable to contain wash water; a front panel disposed in the tub; a cover disposed in the front panel; and a door rotatably coupled to the cover and comprising: a door inner frame; and a door inclined plane disposed between an open center side edge of the door inner frame and an outer edge of the door inner frame, wherein the door further comprises a circuit protection portion protruding toward the cover from a lower outer surface of the door inner frame and is integrally coupled to the door inclined plane. Embodiments include the above and wherein the cover comprises: a laundry inlet; an outer rim; a gap holding portion disposed at a position corresponding to the circuit protection portion and recessed toward the front panel, and wherein the gap holding portion operable to prevent contact with the circuit protection portion when the door is closed; and a cover inclined plane formed between the laundry inlet and the outer rim and operable to not contact an outer surface of the door inner frame. Embodiments include the above and wherein the gap holding portion has a symmetrical shape with respect to a center line connecting upper and lower ends of the cover. Embodiments include the above and wherein a transition portion for a shape-connection between the gap holding portion and the cover inclined plane is formed on an outer surface of the gap holding portion.

Embodiments of the present invention are also drawn to a cover for a wall mounted washing machine, the wall mounted washing machine comprising a cabinet, a tub disposed in the cabinet, the tub operable to contain wash water; a front panel installed in the tub; a cover installed in the front panel and having a door hinge; and a door rotatably coupled to the door hinge and having a door inner frame and a door outer frame coupled to each other, the cover comprising: a gap holding portion that is formed in a recessed shape on the cover to not contact a circuit protection portion protruding from a lower outer surface of the door inner frame toward the cover. Embodiments include the above and further comprising: a laundry inlet; an outer rim; and a cover inclined plane formed between the laundry inlet and the outer rim, the cover inclined plane operable to prevent interference with a door inclined plane of an outer surface of the door inner frame, wherein the cover inclined plane extending along a circumferential direction of the cover.

Embodiments include the above and wherein the door comprises a door gasket and a door glass and wherein further the gap holding portion comprises a gap that prevents contact with the circuit protection portion of the door even if the door glass touches the door gasket. Embodiments include the above and wherein the gap holding portion comprises: a transition portion that comprises a boundary point of a lower inclined plane formed in the door inner frame; a bottom portion extending from the transition portion in an outward direction of the cover; a first corner portion bent in an upwardly inclined direction from an outer edge of the bottom portion; and a first curved surface portion extending from an outer edge of the first corner portion to a channel portion of the outer rim. Embodiments include the above and wherein the bottom portion is disposed in a relatively low level as compared with the channel portion. Embodiments include the above and further comprising: an extension plate protruding downward from the cover and operable for installation of a power processing unit at a periphery of the channel portion adjacent to the gap holding portion; and a water discharge passageway formed on both sides of the extension plate, and wherein a passageway connecting portion is formed between an upper end of the water discharge passageway and the channel portion and operable to allow mutual fluid flow therethrough.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view showing the appearance of a wall mounted washing machine according to an embodiment of the present disclosure;

FIG. 2 is a view showing a state in which the door of FIG. 1 is opened.

FIG. 3 is a rear perspective view of the washing machine of FIG. 1;

FIG. 4 is an exploded perspective view of the washing machine of FIG. 1;

FIG. 5 is an exploded perspective view of a door to illustrate a door opening and closing device mounted on the door in FIG. 2;

FIG. 6 is a sectional view taken along a line A-A of a door inner frame shown in FIG. 5;

FIG. 7 is an exploded perspective view of a cover and a door locking unit shown in FIG. 4;

FIG. 8 is a sectional view taken along a line B-B of a cover shown in FIG. 7;

FIG. 9 is a sectional view taken along a line C-C of the cover shown in FIG. 7;

FIG. 10 is an enlarged sectional view for explaining the gap between the door inner frame and the cover shown in FIG. 5; and

FIG. 11 is a sectional view taken along a line D-D of a cover shown in FIG. 7.

### DETAILED DESCRIPTION

Hereinafter, specific embodiments of the present disclosure will be described in detail with reference to the drawings.

In addition, in the description of the present disclosure, the detailed description of known functions and configurations incorporated herein will be omitted if they would unnecessarily obscure the features of the subject matter of the present disclosure.

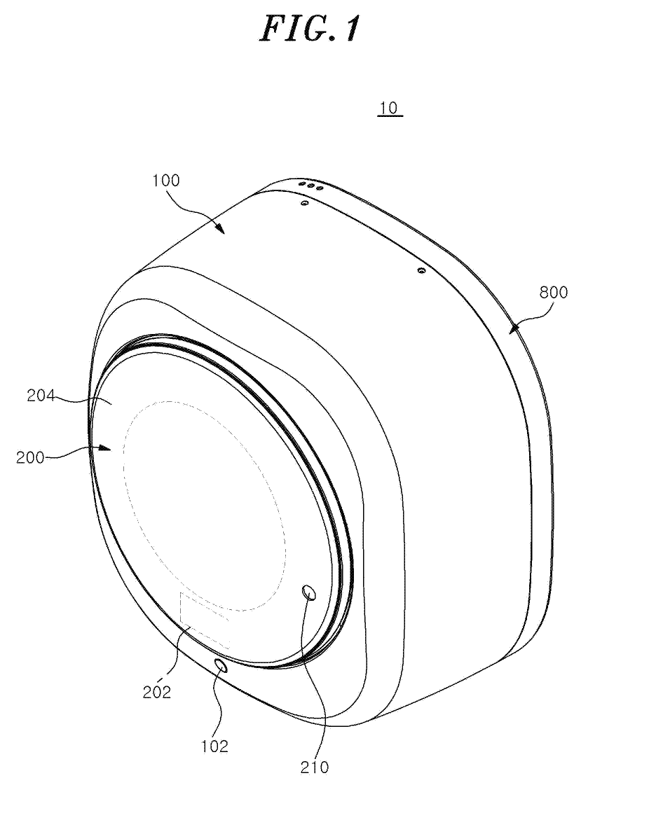

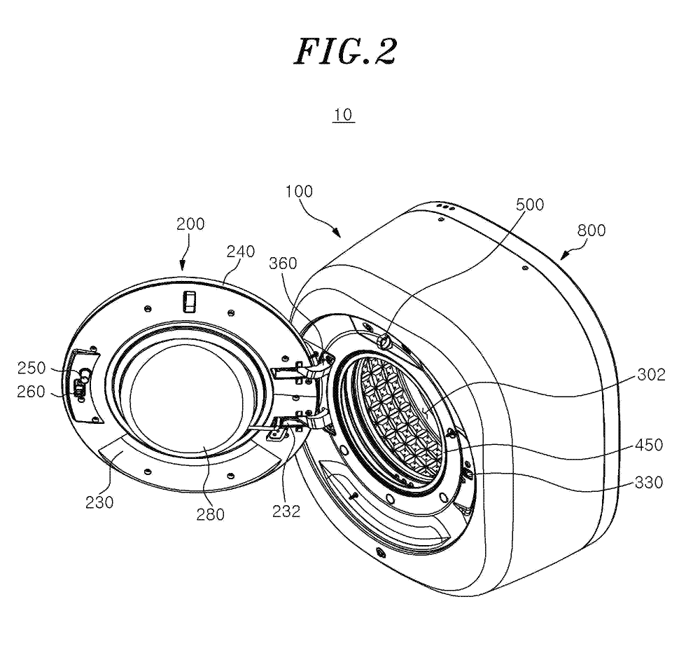

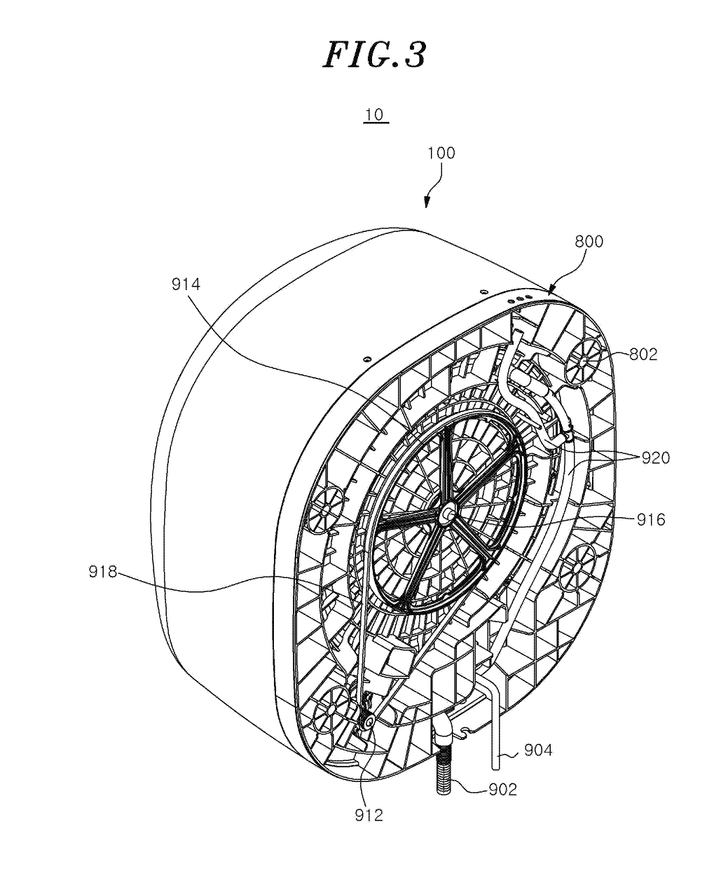

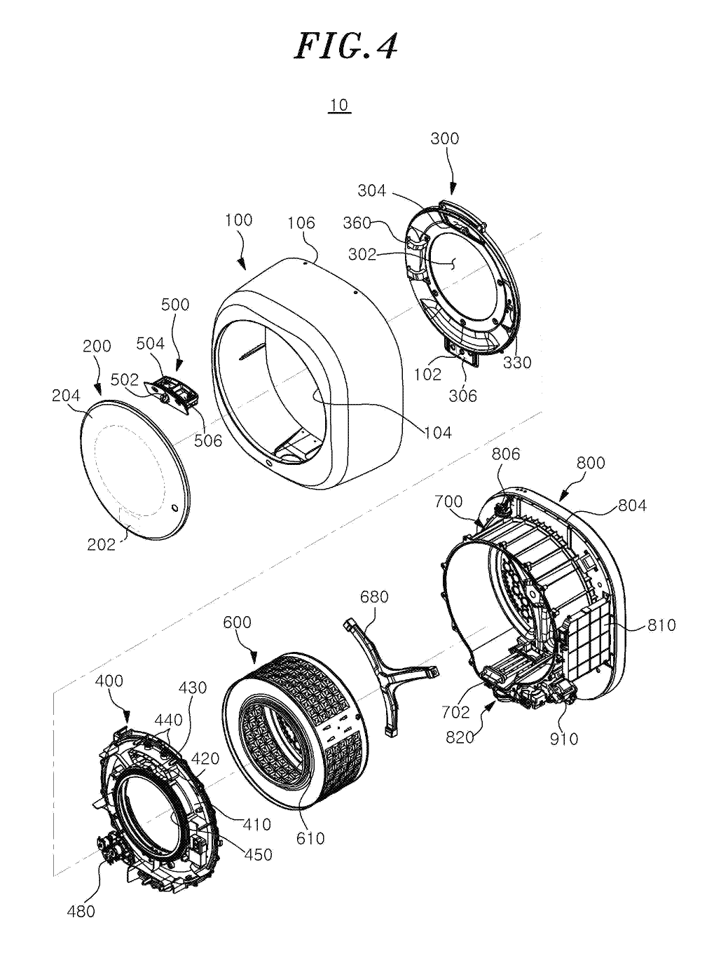

FIG. 1 is a perspective view showing the appearance of a wall mounted washing machine according to an embodiment of the present disclosure, FIG. 2 is a view showing a state in which the door of FIG. 1 is opened, FIG. 3 is a rear perspective view of the washing machine of FIG. 1, and FIG. 4 is an exploded perspective view of the washing machine of FIG. 1.

Referring to FIGS. 1 to 4, a wall-mounted washing machine 10 according to an embodiment of the present disclosure may include a cabinet 100 having a front surface and a rear surface opened and forming an outer appearance or exterior shape thereof, a door 200 disposed on one side of the cabinet 100 and for opening or closing the opened front surface of the cabinet 100, a cover 300 connected to the door 200 for opening and closing the door 200, a front panel 400 disposed on the rear surface of the cover 300, a detergent container 500 housed in one side of the front panel 400 and accommodating detergent and conditioner, a drum 600 in which laundry is stored, a tub 700 which surrounds the drum 600 and is filled with wash water, and a rear panel 800 mounted on the wall. Here, the rear surface means a surface close to the wall, and the front surface means a surface opposite to the rear surface.

Specifically, the cabinet 100 may be provided in an empty form. Also, the cabinet 100 may include a power button 102 for controlling a power supply, a cover connection unit 104 connected to the cover 300, and a rear panel connection unit 106 connected to the rear panel 800.

The power button 102 may be provided on one side of the cabinet 100 to control whether the washing machine 10 is turned on or off. The power button 102 may be provided on one side of the front surface of the cabinet 100 to be easily controlled by the user. Here, in this embodiment, the power button 102 is provided on the lower surface of the front surface of the cabinet 100. However, the position of the power button 102 is not limited thereto, and may be provided on the left or right of the front surface of the cabinet 100, for example, or in other well known positions.

The cabinet 100 may include a cover connection unit 104 connected to the cover 300. The cover connection unit 104 may correspond to an edge of the opened front surface of the cabinet 100 and may have a smaller diameter than the diameter of the cover 300 so that the cover 300 is not detached from the cabinet 100. Specifically, the cover 300 may be inserted into the cabinet 100 from the rear surface to the front surface side. In this case, since the diameter of the cover connection unit 104 is smaller than the diameter of the cover 300, the cover 300 may be fitted into the cover connection unit 104, so that the cover 300 may not be separated from the cabinet 100.

The cabinet 100 may include a rear panel connecting unit 106 connected to the rear panel 800. The rear panel connecting unit 106 may correspond to the opened rear edge of the cabinet 100 and may have a shape that corresponds to the shape of the rear panel 800. The cabinet 100 may be bolted to the rear panel 800 and for this purpose, a plurality of bolt fastening holes may be formed in the rear panel connecting portion 106

Meanwhile, the door 200 may be provided on the front surface of the cabinet 100. The door 200 is provided for loading and unloading laundry, and may include a door inner frame 230 and a door outer frame 240. Specifically, the door inner frame 230 and the door outer frame 240 may be bolted in such way to offer a predetermined space therebetween, and each may be provided in a circular shape having a diameter corresponding to the cover connection unit 104. In this case, the door inner frame 230 may be in contact with the cover connection unit 104, and the door inner frame 230 and the door outer frame 240 may completely shield the cover 300 connected to the cabinet 100.

The door inner frame 230 and the door outer frame 240 may include a door hinge connection unit 232 for connection with the cover 300. The door hinge connecting unit 232 is provided at one side of the door inner frame 230 and the door outer frame 240 and may provide a space for accommodating a door hinge 360 of the cover 300 to be described later.

A display 202 may be provided in a space between the door inner frame 230 and the door outer frame 240. The display 202 is capable of outputting predetermined information to the user, and is provided with a front surface exposed to the outside of the door outer frame 240. That is, the door outer frame 240 may include a hole (not shown) or may be formed of a transparent material so that the display 202 may be viewed. In this case, the display 202 may include a touch panel capable of inputting or outputting information, and the user may view the panel to confirm information such as the operating state through the display 202, and also use the panel to perform operations of the wall-mounted washing machine 10 via touch interactions. For example, the user may select a process such as washing and rinsing of the laundry by performing a touch interaction with respect to the display 202, and confirm the remaining washing time or the like through the display 202.

The display 202 exposed to the exterior of the door outer frame 240 and the door outer frame 240 may be protected through a protective glass 204. The protective glass 204 is transparently provided on the front surface of the door outer frame 240 so that the user may identify the display 202. In this case, the protective glass 204 may be provided with the same diameter as the door inner frame 230 and the door outer frame 240.

A hole (not shown) may be provided on one side of the protective glass 204, and the door opening button 210 may be exposed to the outside through the hole (not shown). The door opening button 210 may be provided in the door outer frame 240 for opening or closing the interior of the cabinet 100 using an electronic opening and closing system and may be exposed to the outside through a hole of the protective glass 204.

In addition, the door 200 may include a door opening unit 250 and a door hanging unit 260. The door opening unit 250 and the door hanging unit 260 may protrude rearward of the door inner frame 230 and may be in contact with and engaged with one side of the cover 300. Specifically, the door opening unit 250 serves as an opening/closing assistant and may have an elastic force. For example, the door opening unit 250 may include a spring and may act as a support for opening the door 200 through the elastic force of the spring. For example, when the door 200 is closed, the door opening unit 250 may be compressed and inserted into a groove (not shown) provided on one side of the cover 300. When the user operates the door opening button 210 to open the door 200, the door opening unit 250 may be released from one side of the cover 300, and may be in contact with the bottom surface of the groove (not shown) provided on one side of the cover 300 in a relaxed state. That is, a space is provided between the door 200 and the cover 300 by the relaxed length of the door opening unit 250, thereby preventing the door 200 from being automatically closed.

The door opening unit 250 may be a pusher stem assembly that may be supported by the spring and located within a guide structure formed in the door inner frame 230 or repeatedly perform projecting by a linear movement through a predetermined stroke range.

The door hanging unit 260 may be provided at a predetermined distance from the door opening unit 250 and may be provided in the shape of a hook partially protruding from the door inner frame 230. The protruding portion of the door hanging unit 260 may be coupled to a door lock unit 330 of the cover 300 to be described later, and thus the door 200 may be closed.

In summary, the door 200 according to one embodiment of the present disclosure may be opened through a door opening button 210. When the user operates the door opening button 210, the door opening unit 250 and the door hanging unit 260 may be released from the cover 300 so that the door 200 may open the cover 300. In this case, the door opening unit 250 having an elastic force may be relaxed and provided on one side of the cover 300, and thus a predetermined gap is provided between the door 200 and the cover 300. Therefore the door 200 may be prevented from closing.

In addition, the user may close the door 200 by applying pressure to the door 200 toward the cover 300 side. To this end, the user may press one side of the outermost protective glass 204 of the door 200 so that the door opening unit 250 may be compressed and become received in the groove (not shown) of the cover 300 and the protruding portion of the door hanging unit 260 may be coupled to the door hanging unit 330 of the cover 300. That is, the door 200 may be opened and closed without a separate handle.

A center side of the door inner frame 230 and the door outer frame 240 may be opened and the door glass 280 may be provided at the opened center side. The door glass 280 allows the user to view the laundry inside the machine from the outside of the washing machine 10 and may be fitted to the door inner frame 230 and the door outer frame 240. In this case, the door glass 280 may be formed to protrude rearward, and the protruded side of the door glass 280 may be fitted to the opened side of the cover 300.

Meanwhile, the door 200 may be rotatably connected to the cover 300. The cover 300 is provided to enclose the front panel 400 and may include a laundry inlet 302 for loading the laundry, a detergent container loading port 304 for loading a detergent container 500, and a power processing unit 306 for controlling the button 102.

The user may load laundry through the laundry inlet 302. The laundry inlet 302 may be provided to have a predetermined diameter. In this case, the diameter of the laundry inlet 302 may correspond to the size of the protruding portion of the door glass 280. Thus, when the door 200 is closed, the door glass 280 may block the laundry inlet 302, and when the user opens the door 200, the door glass 280 is released from the laundry inlet 302 to allow laundry loading through the laundry inlet 302.

A detergent container loading port 304, which may load the detergent container 500, may be provided on the upper side of the laundry inlet 302. In this case, the detergent container loading port 304 may correspond to the shape of the detergent container 500.

The cover 300 may have a laundry inlet 302 at its center and may have a circular shape as a whole. Further, the cover 300 may be shaped such that one side protrudes downward. In this case, the power processing unit 306 may be provided in a protruding portion downward. The power processing unit 306 may be a PCB substrate connected to the power button 102 to control whether the power is turned on or off according to the operation of the power button 102 protruding from the outside of the case 100.

Meanwhile, the cover 300 may include a door hanging unit 330 located at a position corresponding to the other door hanging unit 260. The door hanging unit 330 is coupled to the hook-shaped door hanging unit 260 and may include a groove corresponding to the shape of the door hanging unit 260. Thus, as the door hanging unit 260 is coupled to the other door hanging unit 330, so that the door 200 may close the laundry inlet 302.

Also, the cover 300 may include a door hinge 360 at a location corresponding to the door hinge connection unit 232. The door hinge 360 may be opened while one side of the door 200 and one side of the cover 300 may be connected to each other, and the one side of the door hinge 360 may be received in the door hinge connection unit 232. Specifically, the door hinge 360 may be formed in a shape of a long curved panel in a vertical direction on one side of the laundry inlet 302, and may be partially protruded forward such that the door 200 may be rotated and connected to the door hinge connection unit 232. That is, the door 200 may be rotatable along the protruding portion in front of the door hinge 360.

Meanwhile, a front panel 400 may be provided on the rear surface of the cover 300. The front panel 400 may be coupled to the tub 700 and may include a shield unit 410 shielding a space between the drum 600 and the tub 700, a detergent container receiving unit 420 receiving the detergent container 500, a detergent container gasket 430 which provides a seal at a portion coupled with the detergent container 500, a fitting 440 for supplying water into the detergent container 500, a door gasket 450 which provides a seal at a portion in contact with the door 200, and a water supply valve assembly 480 for receiving wash water from an external water supplying source.

The shield unit 410 may shield a space generated between the drum 600 and the tub 700 and may have a shape corresponding to the shape of the cover 300. That is, it may have the same diameter as the cover 300 and have an opening corresponding to the laundry inlet 302 provided on the center side thereof. In this regard, the opening of the shield unit 410 may be smaller than the diameter of the drum 600, so that the space between the drum 600 and the tub 700 may be shielded.

The detergent container receiving unit 420 may be provided at one side of the shield unit 410 to receive the detergent container 500. The detergent container receiving unit 420 may have a shape corresponding to the shape of the detergent container 500 and may be in communication with the detergent container loading port 304 of the cover 300. That is, the detergent container 500 may be received in the detergent container receiving unit 420 via the detergent container loading port 304 of the cover 300.

The detergent container receiving unit 420 may include a detergent container gasket 430 that is pressurized by the detergent container 500. The detergent container gasket 430 may be disposed around the end of the detergent container receiving unit 420 to seal the detergent container 500 and may be composed of a rubber material. That is, the detergent, the conditioner, and the wash water supplied to the detergent container 500 are prevented from leaking to the outside through the detergent container gasket 430.

At least one fitting 440 may be provided on the top of the detergent container receiving unit 420. The fitting 440, which is connected to a water supply valve assembly 480 connected to an external water supply source, may supply the wash water into the detergent container 500. Thus, the wash water supplied to the drum 600 and the tub 700 may include the dissolved detergent or conditioner because the wash water is supplied into the drum 600 and the tub 700 through the detergent container 500.

Meanwhile, the opening of the shield unit 410 may include a door gasket 450 which is pressed by a door glass 280 of the door 200. The door gasket 450 may be disposed at the opening end of the shield unit 410 (for example, at the annular end of the opening) to hermetically fix the door glass 280, and it may be composed of a rubber material or the like. Thus, when the door 200 is closed, the door glass 280 penetrating the laundry inlet 302 of the cover 300 presses the door gasket 450, and therefore the wash water inside the drum 600 and the tub 700 will not leak outside the door 200.

The fitting 440 may be supplied with wash water through a water supply valve assembly 480. The water supply valve assembly 480 may be connected to an external water supply source and may selectively supply the wash water to the detergent container 550 through the fitting 440. The water supply valve assembly 480 may be a three-way valve and two of the supply flow paths extending from the water supply valve assembly 480 may be connected to the fitting 440 connected to the detergent container 500 and one of them may supply the wash water to the drum 600 directly through the door gasket 450.

The detergent container 500 may accommodate detergent and conditioner and may include a detergent container handle 502, a detergent input space 504 in which detergent is loaded, and a conditioner input space 506 in which a conditioner is loaded.

The detergent container handle 502 may protrude forward and may be exposed to the outside of the cover 300. The user thus may grasp the detergent container handle 502 after opening the door 200, allowing the detergent container 500 to be unloaded or inserted from the detergent container receiving unit 420. In this embodiment, although the detergent container handle 502 is extended in the vertical direction and provided at the center of the front surface of the detergent container 500, the detergent container handle 502 is not limited thereto. For example, the detergent container receiving unit 420 may be extended in the horizontal direction and provided on the front surface of the detergent container 500.

The detergent container 500 may be partitioned based on the center of the interior and include a detergent input space 504 and a conditioner input space 506 which may contain detergent and conditioner, respectively. In this connection, the fitting 440 may be arranged to correspond with the detergent input space 504 and the conditioner input space 506, and the detergent and conditioner in the detergent input space 504 and the conditioner input space 506 may be supplied with the wash water. Specifically, the user may draw the detergent container 500 from the detergent container receiving unit 420 after opening the door 200 and may fill detergent and conditioner into the detergent input space 504 and the conditioner input space 506, respectively. The detergent container 500 filled with the detergent and the conditioner may be inserted again into the detergent container receiving unit 420, and depending on the washing process, the detergent input space 504 and the conditioner input space 506 may be supplied with the wash water. Accordingly, the wash water including detergent or conditioner may be selectively supplied to the drum 600 and the tub 700.

Meanwhile, the front panel 400 may be connected to the drum 600. The drum 600 for receiving the laundry may include a drum inlet portion 610 on the front surface and a spider 680 on the rear surface. In this case, a plurality of holes may be formed around the drum 600 for fluid communication with the tub 700.

A drum inlet portion 610 may correspond to the opened portion of the shield unit 410. In this regard, the drum inlet portion 610 may have a diameter smaller than the entire diameter of the drum 600, and the drum inlet portion 610 may be fitted into the opened portion of the shield unit 410, so that front panel 400 and the drum 600 may be connected to each other. Thus, the laundry may be loaded into the drum 600 via the laundry inlet 302 of the cover 300 and the opened portion of the front panel 400.

The drum 600 may be rotated through a spider 680. The spider 680 may rotate in response to a driving force from a driving motor 910 (to be described later). The spider 680 may be separate from the drum 600 and also coupled to the rear surface of the drum 600. In this case, a groove corresponding to the shape of the spider 680 may be formed on the rear surface of the drum 600 so that the spider 680 may be seated.

The spider 680 may include a plurality of arms extending in different directions with a constant gap at the center. For example, the spider 680 may include an arm extending in three directions by a length corresponding to the radius of the drum 600, and each arm may be disposed at a 120-degree gap. Further, the center of the spider 680 may be fixed to a second pulley 914 (to be described later) through a drum rotation axis 916 to be described later, and thus both the drum 600 coupled to the spider 680 and the spider 680 may be rotated. A specific method of rotating the drum 600 will be described later.

A tub 700 in which the wash water is filled may be provided outside the drum 600. The tub 700 may have a shape corresponding to the drum 600 and may be formed with a diameter larger than a diameter of the drum 600 by a predetermined length. Accordingly, the tub 700 may be arranged apart from the drum 600 by a predetermined gap. In addition, the wash water supplied into the tub 700 may flow into the drum 600 through a plurality of holes formed around the drum 600. Similarly, the inner wash water of the drum 600 may flow into the tub 700 through the plurality of holes formed around the drum 600. In this regard, the drum 600 and the tub 700 may be provided in a cylindrical shape, but of course are not limited thereto.

Further, the tub 700 may include a heater 702 to heat the wash water. Specifically, a groove may be formed on the inner side of the tub 700 to receive the heater 702, and a heater 702 may be provided on the inner side of the tub 700 in a detachable manner. Thus, the heater 702 may heat the wash water filled in the tub 700.

Meanwhile, the tub 700 may be integrally provided with a rear panel 800. The rear panel 800 may be mounted on the wall and may include an anchor connection unit 802 to which an anchor (for mounting to the wall) is connected, a cabinet fixing unit 804 for fixing the cabinet 100, and a sensor 806 for detecting the water level.

Specifically, the tub 700 and the rear panel 800 may be integrally injection molded, and the tub 700 may protrude from the front of the rear panel 800. The rear surface of the rear panel 800 may be mounted on the wall via a separate anchor. The anchor may be coupled to the wall through an anchor connection unit 802 and may be provided on the rear surface of the rear panel 800 for stable engagement. That is, the plurality of anchors may mount the rear panel 800 on the wall. In this case, since the tub 700 and the rear panel 800 are integrally provided, a separate damper or an elastic member for supporting the tub 700 is not required. Consequently, the number of parts may be reduced, and the size of the washing machine 10 may be likewise reduced.

The cabinet 100 may be coupled to the front surface of the rear panel 800 where the tub 700 is provided to enclose the tub 700. In this case, a cabinet fixing unit 804 may be provided to have a stepped shape along the periphery of the rear panel 800, and the cabinet 100 may be fixed to the cabinet fixing unit 804. For this purpose, a fastening member such as a bolt may be used.

Also, the rear panel 800 may include a control unit 810 for controlling the overall functions of the wall mounted washing machine 10 and a drain unit 820 for discharging the wash water filled in the tub 700.

The control unit 810 may be provided on the front surface of the rear panel 800 to control various components of the wall mounted washing machine 10 depending on a user's operation to perform laundry washing. In this embodiment, while the control unit 810 is shown on the right side of the respect to tub 700, the position of the control unit 810 is not limited thereto.

A power supply line 904 may be connected to the external power source to supply power to the electric equipment, the control unit 810, the driving motor 910, and the like described above. The power supply line 904 may extend through the rear panel 800 to the front of the rear panel 800 and may extend outwardly from the rear of the rear panel 800. In this case, the power supply line 904 may be fixed to the rear surface of the rear panel 800 through a separate fixing means. As the power supply line 904 is provided extending outwardly from the rear surface of the rear panel 800, the washing machine 10 may have a finished or pleasing appearance.

The drain unit 820 may be provided under the rear panel 800. The drain unit 820 may discharge any wash water inside the tub 700 to the outside and may be disposed on the lower surface of the front surface of the rear panel 800. In this case, the drain unit 820 may include a drain pump for pressurizing the wash water and may be connected to the drain hose 902 to discharge the wash water. Specifically, the drain hose 902 is connected to the drain unit 820 and extends outward along the rear surface of the rear panel 800, so that the wash water may flow through the pressure of the drain unit 820. Thus, when the drain unit 820 is operated after the washing cycle is completed, the wash water may be discharged to the outside of the cabinet 100 through the drain hose 902 under the pressure change of the drain unit 820.

Meanwhile, the rear panel 800 may include a driving motor 910 for transmitting a driving force to the rear panel 800, a first pulley 912 and a second pulley 914 connected to the driving motor 910, a drum rotational shaft 916 connected to the second pulley 914 to rotate the drum 600, and a belt 918 that connects the first pulley 912 and the second pulley 914.

Specifically, the driving motor 910 may be provided on the front surface of the rear panel 800. The driving motor 910 may be controlled by the control unit 810 and may be provided on one side of the control unit 810 and the drain unit 820.

Also, the driving motor 910 may be connected to the first pulley 912. In this case, the shaft (not shown) of the driving motor 910 may be provided through the rear panel 800 and may be connected with a shaft (not shown) of the driving motor 910 to the first pulley 912 at the rear surface of the rear panel 800.

The first pulley 912 may be connected to the second pulley 914 via a belt 918. The second pulley 914 may be provided to surround the drum rotation shaft 916 connected to the spider 680 and the drum rotation axis 916 may penetrate the rear panel 800 while being connected to the spider 680. That is, the second pulley 914 and the drum rotation shaft 916 may be connected to each other at the rear surface of the rear panel 800.

In summary, when the wash water is filled in the tub 700 through the fitting 440, the control unit 810 may operate the driving motor 910. Subsequently, the first pulley 912 connected to the driving motor 910 may be rotated, and the second pulley 914 may be then rotated by the rotation of the first pulley 912. Thus, the drum rotation shaft 916 connected to the second pulley 914 may also rotate so that the drum 600 may be rotated inside the cabinet 100 and the tub 700. Consequently, the laundry inside the drum 600 may be washed.

On the other hand, the rear panel 800 may further include an exhaust line 920. The exhaust line 920 may be connected to the drain unit 820 and may exhaust air inside the tub 700 and the drain unit 820. Specifically, the exhaust line 920 may be connected to the drain hose 902 and pass through the rear panel 800, through which it may extend to the rear surface of the rear panel 800 and be exhausted to the outside.

The wall-mounted washing machine 10 according to an embodiment of the present disclosure may be used as follows.

First, the user may open the door 200, and may load the laundry inside the drum 600 and unload the detergent container 500 from the front panel 400. In this case, the detergent container 500 is divided in the center, so that a space for loading detergent and conditioner, respectively, may be provided.

After inserting the detergent container 500 loaded with the detergent and conditioner back into the front panel 400, the user may close the door 200 and control the laundry operation via the power button 102 and the display 202. When the washing cycle is started, the wash water provided from an external water supplying source through the water supply valve assembly 480 may be supplied to the detergent container 500 through the fitting 440, and the wash water may be supplied into the drum 600 and tub 700 after passing the detergent input space 504 and the conditioner input space 506. That is, the wash water filled in the drum 600 and the tub 700 may optionally include detergent and conditioner. When the tub 700 is fully filed with the wash water, the control unit 810 may drive the driving motor 910. In this case, the driving motor 910 may be connected to the first pulley 912 and the second pulley 914, and the second pulley 914 may be connected to the drum 600 through the drum rotation shaft 916. Thus, the drum 600 may be rotated through the driving motor 910. Consequently, the laundry loaded in the drum 600 may be easily washed by the rotation of the drum 600.

When the door 200 is closed, the door 200 may rotate toward the cover 300, and when the door 200 is opened, the door 200 may be reversely rotate away from the cover 300.

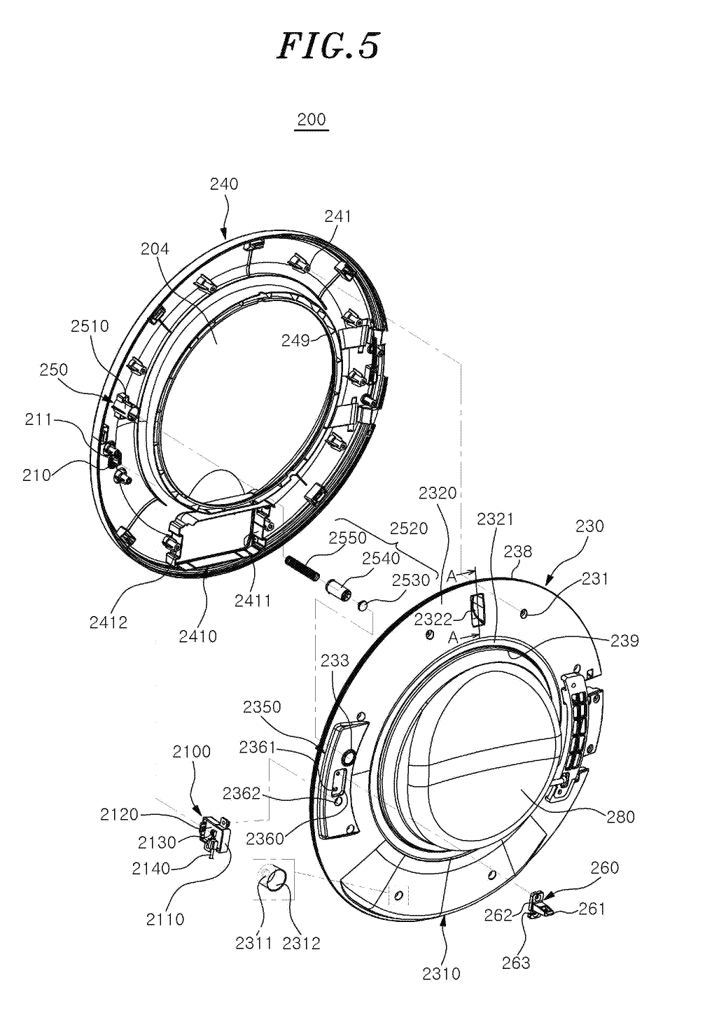

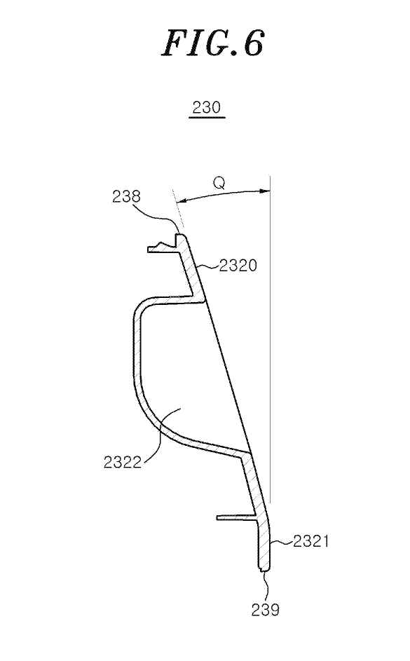

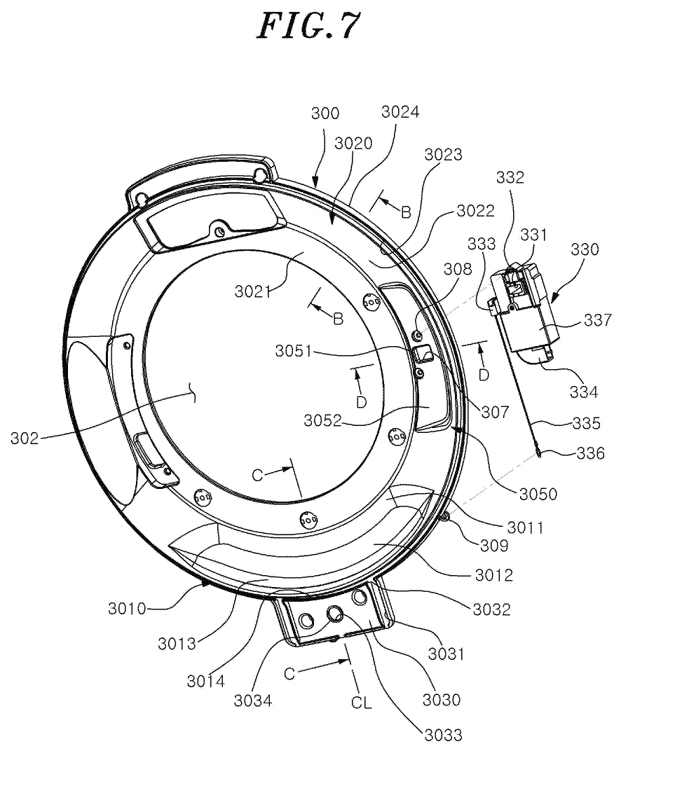

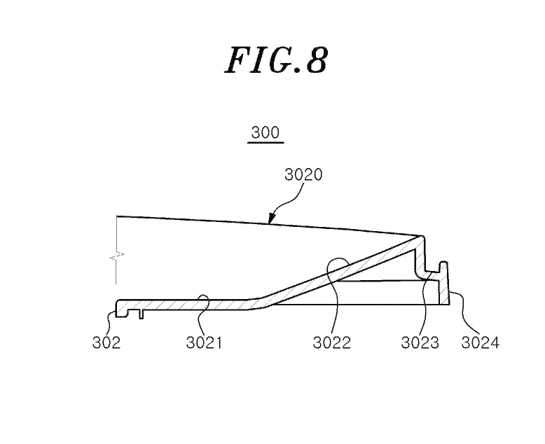

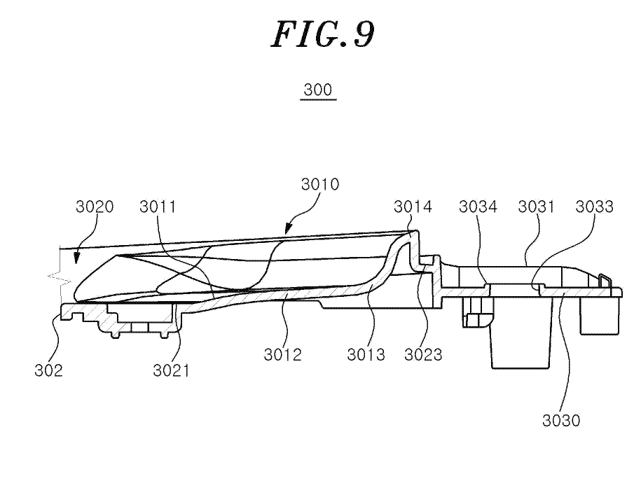

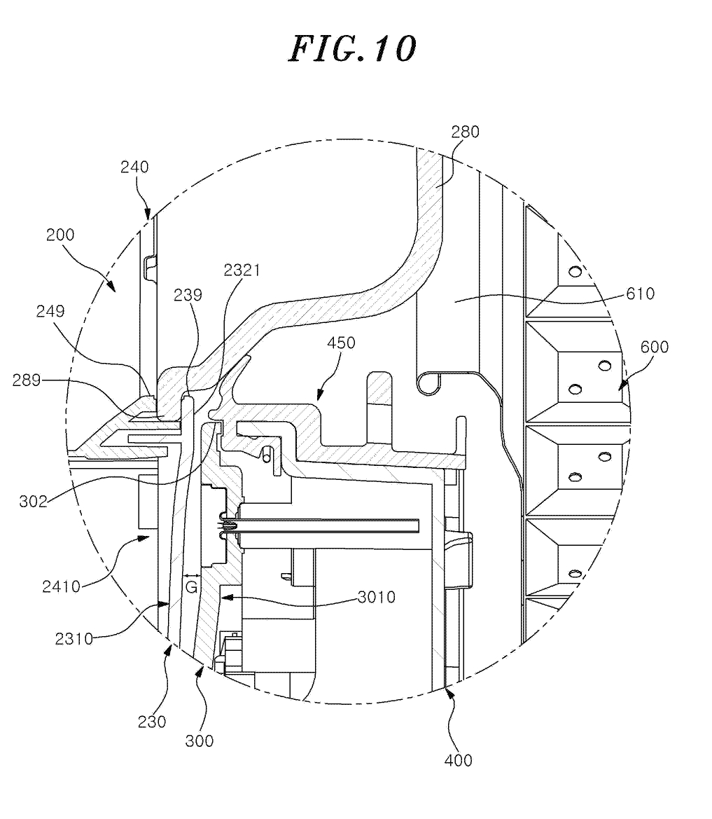

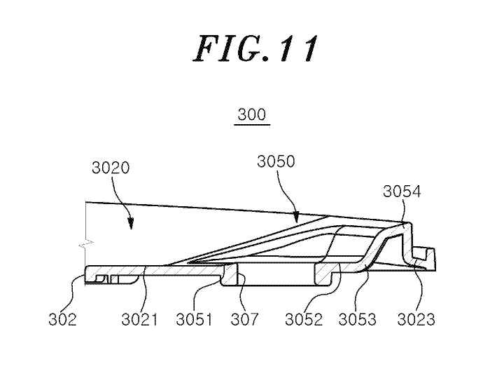

FIG. 5 is an exploded perspective view of a door for describing the door opening and closing device installed at door of FIG. 2 and FIG. 6 is a sectional view taken along a line A-A of a door inner frame shown in FIG. 5. Further, FIG. 7 is an exploded perspective view of the cover and the door locking unit shown in FIG. 4 and FIG. 8 is a sectional view taken along a line B-B of a cover shown in FIG. 7. Further, FIG. 9 is a sectional view taken along a line C-C of the cover shown in FIG. 7, FIG. 10 is an enlarged sectional view for explaining the gap between the door inner frame and the cover shown in FIG. 5, and FIG. 11 is a sectional view taken along a line D-D of a cover shown in FIG. 7.

Referring to FIGS. 5 to 11, the wall mounted washing machine includes a door opening and closing device that is provided on the door 200 and may be electronically opened and closed, and means for preventing interference between the door 200 and the cover 300.

The door 200 includes a door inner frame 230 and a door outer frame 240 configured to be separated or assembled as described above. The door 200 may be an assembly which includes the inner frame 230 and the door outer frame 240 which are assembled together.

The door opening and closing device may be an electronic device capable of opening the door 200 in accordance with an embodiment. That is, even if the door opening button 210 is simply pressed by the user's finger, the locking state of the door 200 may be released, thereby facilitating user convenience. In addition, the door opening and closing device allows the door 200 to be opened easily and quickly.

For example, the door opening and closing device may readily open the door 200 by utilizing a resultant force summing an elastic force of the door opening unit 210 including the pusher stem assembly 2520 and the elastic force of the door gasket 450 of FIG. 4, e.g., a bending force.

For example, the door gasket 450 has an elastic protrusion protruding obliquely toward the door glass 280, and is bent when the door 200 is closed which applies the elastic force, such as a bending force, to the door 200 through a door glass 280.

In other words, in the unlocking state in which the door 200 may be opened, the elastic protrusion of the door gasket 450 may be restored to the original state, and the door 200 may be pushed by an elastic force corresponding to the bending force. In this situation, the acting direction of the elastic force of the door gasket 450 may be the same as the acting direction of the elastic force of the door opening unit 250, so that the door 200 may open quickly.

The door opening and closing device may include the door opening unit 250, the door locking unit 330 and the door hinge 360, as shown in FIG. 4; and the door opening and closing device may further include a door hanging unit 260, an opening button circuit module 2100 and a door opening button 210, as shown in FIG. 5.

The door hinge 360 may be disposed on one side of the cover 300 and may be rotatably coupled to the door 200.

The door locking unit 330 may be provided on the other side of the cover 300.

The door hanging unit 260 may be made of a metal material having a larger structural strength than that of the door 200, and is detachably attached to the door 200 by a fastening means such as a bolt.

For example, the door hanging unit 260 is mounted on the door 200. That is, the door hanging unit 260 may be in the form of a hook protruding out of the door inner frame 230, or in the form of a ring protruding from the door inner frame 230 toward the cover 300. The door hanging unit 260 may be a component (e.g., locking component) coupled to the door locking unit 330 of FIG. 3 or FIG. 4 mentioned above or may be a component (e.g., unlocking component) unlocking from the door locking unit.

The door locking unit 330 may be a device capable of locking or unlocking the door hanging unit 260 using an elastic force and an electromagnetic force, in one embodiment.

The door locking unit 330 may unlock the door hanging unit 260 depending on the door lock release signal from the control unit 810 or may unlock the door hanging unit 260 by a manual lock release as described below.

The door locking unit 330 is disposed on the cover 300. The door locking unit 330 may lock the door hanging unit 260 when the door locking unit 330 is coupled to the door hanging unit 260.

To this end, the door locking unit 330 is connected to a control unit 810 in the washing machine 10. In a detailed configuration, the door locking unit 330 may be an electro-mechanical locking device having a latch for locking or unlocking the door hanging unit 260 and a mechanism for operating the latch and an electrical powering device. Here, the electric power unit is configured to be controllable by the control unit 810.

As such, the door locking unit 330 may release the locking state of the door hanging unit 260 in response to an operation control event, such as a door unlocking signal of the control unit 810 located in the cabinet 100.

The door opening unit 250 is installed in the door 200 as mentioned above. The door opening unit 250 rotates together with the door 200 to contact the cover 300. Subsequently, the spring 2550 of the door opening unit 250 is compressed, so that an elastic force may be generated in the spring 2550 or stored in the spring 2550.

Further, the door opening unit 250 may include a guide structure 2510 described below and a pusher stem assembly 2520 guided by a guide structure 2510.

In addition, the door opening unit 250 may play a role of generating a force required to open the door 200. For example, the door opening unit 250 is a device that may be stretched or contracted, e.g., that may be capable of expansion and contraction within a predetermined stroke range using an elastic force. In other words, the door opening unit 250 may serve as a pusher device for easily and rapidly opening the door 200 using an elastic force. That is, the door opening unit 250 may reverse the door by the stored elastic force.

Moreover, the door opening unit 250 may serve as an elastic support or a spacer. That is, in an open state of the door 200, the door opening unit 250 may maintain a space between the door 200 and the cover 300 until the user applies a force to the door of a sufficient magnitude to close the door 200.

To this end, the door opening unit 250 is installed on the door 200 with respect to a position spaced apart from the door hanging unit 260.

The door inner frame 230 is arranged toward the cover 300 and has a plurality of bolt holes 231 and a stem through hole 233. The stem through hole 233 is formed so that it passes through along a direction in accordance with the frame thickness (e.g., the frame thickness direction) of the door inner frame 230 with respect to a position spaced from the door hanging unit 260.

A protective glass 204 is coupled to the outer side of the outer frame 240.

The door outer frame 240 may be act as a support base of the door opening unit 250.

The door outer frame 240 is coupled to the door inner frame 230 through a bolt (not shown) corresponding to the bolt hole 231. For this purpose, the door outer frame 240 includes a plurality of bolt fixing parts 241 spaced apart from one another along the circumferential direction from the inner side of the door outer frame 240 so that the bolts inserted into the bolt holes 231 are coupled to the bolt fixing parts.

The door outer frame 240 includes a door opening button 210 disposed in the door outer frame 240, in one instance, with respect to a position that does not interfere with the bolt fixing part 241.

The outer side of the door opening button 210 may be exposed through a hole (not shown) on one side of the protective glass 204, as mentioned above.

The door opening button 210 includes a button extending portion 211 that is an integral shaft member protruding from the center of the inner side thereof toward the inner side of the door inner frame 230.

A swirling elastic body is formed between an outer edge of the door opening button 210 and an inner edge of a button hole edge of the door inner frame 230.

Accordingly, the user may perform a pressing operation for opening the door 200, such as pressing the door opening button 210 on the outside of the door 200 with a finger. Then, since the swirling elastic body is deformed within the elastic range, the door opening button 210 and the button extending portion 211 may be advanced during the pressing operation, and may be restored (e.g., backward) to the original state when the finger releases the door opening button 210.

Meanwhile, the door inner frame 230 includes an opening button circuit module 2100 installed on the inner side of the door inner frame 230 to be in contact with the end of the button extending portion 211.

The opening button circuit module 2100 is installed at a position, e.g., the inner side of the door inner frame 230, spaced downwardly away from the stem through hole 233 of the door inner frame 230.

The opening button circuit module 2100 has a circuit housing 2110 that may be bolted to the inner side mounting position of the door inner frame 230. One side of the circuit housing 2110 is open.

The opening button circuit module 2100 includes a switch circuit board unit 2120 installed on the circuit housing 2110 through the open side. Here, the opening button circuit module 2100 perform the function of issuing the locking release signal to the control unit 810 of the washing machine 10 according to a selective ON or OFF operation of the door opening button 210, the button extension portion 211 and a contact switch 2130. The contact switch 2130 may be mounted on the switch circuit board unit 2120 and may be in contact with the end of the button extending portion 211.

The opening button circuit module 2110 includes a cable 2140 (or signal wire) for electrically connecting the switch circuit board unit 2120 and the control unit 810. Herein, the cable 2140 may be connected to the control unit 810 via a circuit (not shown) associated with the display 202 mentioned above.

The door opening unit 250 will be described below in detail.

The guide structure 2510 of the door opening unit 250 serves to guide the movement of the pusher stem assembly 2520. The guide structure 2510 may be integrally formed on the inner side of the door outer frame 240. More specifically, the guide structure 2510 serves to guide the forward (e.g., stretch) or backward (e.g., collapse) movement of a stem 2540 of the pusher stem assembly 2520. The guide structure 2510 also serves to restrain or protect the spring 2550 so that the spring 2550 is selectively separated, or not separated, from the outside of the stem 2540.

The pusher stem assembly 2520 of the door opening unit 250 may be coupled to the guide structure 2510 and elastically supported on the inner side of the door outer frame 240. The cushion 2530 of the pusher stem assembly 2520 may be in contact with the cover 300. The stem 2540 of the pusher stem assembly 2520 may be fitted into the stem through hole 233 of the door inner frame 230.

The pusher stem assembly 2520 may be compressed upon contacting the cover 300.

As the door 200 is closed, the pusher stem assembly 2520 may be supported and guided in the inside of the guide structure 2510 and act on the cover 300 with the elastic force stored by the compression of the spring 2550.

In contrast, as the door 200 is opened, the pusher stem assembly 2520 may be extended toward the cover 300 through the stem through hole 233. The pusher stem assembly 2520 is supported and guided by the guide structure 2510 and acts on the cover 300 with the elastic force stored.

The cover 300 is a fixed component of the washing machine 10 supported on the wall. The door 200 is a rotatable component in the door hinge 360 of the cover 300.

Accordingly, in a state in which the door 200 may be opened by unlocking of the door hanging unit 260 and the door locking unit 330, the pusher stem assembly 2520 may be moved with the door 200 along the door opening direction by the reaction of the elastic force, e.g., elastic repulsive force from the relaxation or extension of the spring 2550.

The pusher stem assembly 2520 includes a cushion 2530 that contacts the cover 300 in response to the rotation of the door 200. The pusher stem assembly 2520 includes a spring 2550 inserted into the stem 2540 and selectively compressed or relaxed along the longitudinal direction of the stem 2540.

The cushion 2530 serves to attenuate and reduce impacts and noise upon contacting the cover 300 to increase the operating quality of the washing machine 10.

For this purpose, the cushion 2530 is formed of at least one material selected from the group consisting of: a natural rubber material; a synthetic rubber material; a urethane material; a silicone material; and a synthetic resin material having an elastic force.

Further, the cushion 2530 contacts the cover 300 to absorb the impact.

Hereinafter, the operation of the door opening and closing device of the wall-mounted washing machine according to the disclosure will be described.

Referring to FIG. 2, the user rotates the door 200 shown in FIG. 2 to the state shown in FIG. 1 to close the door 200.

During the rotation, the door 200 approaches the cover 300 and the door hanging unit 260 of the door 200 is engaged and locked to the door locking unit 330 so that the door 200 is closed.

In this case, the pusher stem assembly 2520 may also be moved with the door 200, and the cushion 2530 of the pusher stem assembly 2520 can be brought into contact with the cover 300. By the continuous rotation of the door 200, that is, as the user pushes the door 200 further against the cover 300, the stem 2540 of the pusher stem assembly 2520 goes back and the spring 2550 is compressed by the backward movement of the stem 2540, and the door is closed.

In operation, the user presses the door opening button 210 shown in FIG. 1.

Then, the locking state of the door locking unit 330 to the door hanging unit 260 of the door 200 shown in FIG. 2 is released.

At this time, as the door opening unit 250 is relaxed, the length of the spring 2550 of the door opening unit 250 is extended.

Further, because the cover 300 and the components of the washing machine 10 coupled thereto are fixed to the wall, they do not move despite the extension of the spring 2550.

Instead, the elastic force of the spring 2550 is transmitted to the cover 300 through the stem 2540 and the cushion 2530. In addition, the elastic repulsive force (e.g., pushing force) corresponding to the elastic force is transmitted to the door 200 through the guide structure 2510, and as a result, the door 200 is reverse-rotated in the opened direction.

That is to say, the guide structure 2510 and the pusher stem assembly 2520 which are parts of the door opening unit 250 of the door 200 are moved together with the door 200 by the reaction of the elastic force of the spring 2550 during the relaxation or extension of the spring 2550, thereby creating an open state.

Hereinafter, the description will focus on the manual release action of the door opening and closing device.

Referring to FIG. 7, the door locking unit 330 includes a locking device casing 337, a manual lever 333, and a string member 335.

The string member 335 plays a role of pulling the manual lever 333.

The manual lever 333 operates on leverage principles and pivots the inner latch (not shown) of the locking device casing 337 by the string member 335 so that the door hanging unit 260 shown in FIG. 2 can become manually separated or unlocked from the door locking unit 330.

The cover 300 includes a string mounting portion 309 for fixing the string member 335 of the door locking unit 330. Here, the string mounting portion 309 protrudes from the lower edge of the cover 300 toward the outside of the cover 300.

The string mounting portion 309 may operate in various ways. It may be a means or mechanism for binding and fixing the string member 335 or fixing steady the end of the string member 335, or may be a support base capable of holding the string member 335 tightly.

For example, the string mounting portion 309 may be integrally formed with the lower edge of the cover 300 and may be formed of various different materials including any one of a hook portion, a ring portion, and/or a line fitting portion for fixing the end of the string portion 335.

As mentioned above, the cover 300 includes the hanging unit insertion hole 307 formed in the thickness direction of the cover in order to pass the protruding portion of the door hanging unit 260 with respect to the direction from the door 200 toward the cover 300. Here, the hanging unit insertion hole 307 may be formed in the form of a rectangular hole having a rounded corner portion.

The cover 300 further includes the bolt fastening mounting holes 308 formed on the cover 300 around the hanging unit insertion hole 307. The door locking unit 330 can be screwed to the bolt of the bolt fastening mounting hole 308 and tightly fixed to the back surface of the cover 300.

In addition, the string member 335 may transmit a tensile force to the manual lever 333, such as a cord, a string, a flexible wire, or the like. In particular, since the string member 335 is made of a flexible material, its vibration transmission efficiency is lowered, and therefore it does not generate any appreciable friction noise due to contact action.

Embodiments of the present invention therefore provide the advantages that vibration transmission efficiency is lowered and friction noises (due to contact) are generally not made. The locking device casing 337 is installed on the rear surface, e.g., the back surface, of the cover 300, and includes a latch capable of locking and unlocking the door hanging unit 260, a mechanism for operating the latch, and an electric power unit. The mechanism for operating the latch is connected to a lever connecting member (not shown) extending from the manual lever 333 to the inside of the locking device casing 337 so that the mechanism can receive the operating force from the manual lever 333.

The manual lever 333 is exposed to the outside of the locking device casing 337 and operates the latch by manual operation.

The upper end of the string member 335 is installed on or coupled to the manual lever 333.

That is, the string member 335 is connected to the manual lever 333 and extends downward from the manual lever 333. For example, the upper end portion of the string member 335 may be combined with the manual lever 333 at the injection molding phase of the manual lever 333, or after the manual lever 333 is manufactured, and may be connected to the manual lever 333 using various different methods, such as, by a binding method, a connecting method using a fixing clip, or the like.

In order to facilitate the engagement or attachment between the string member 335 and the string mounting portion 309 of the cover 300, the string member 335 may further include a ring portion 336 formed at the lower end of the string member 335 and detachably coupled to the string mounting portion 309.

The door locking unit 330 includes a hanging unit inlet port 331 formed in the locking device casing 337 and located at a position corresponding to the hanging unit insertion hole 307 of the cover 300. The hanging unit inlet port 331 may also be a rectangular hole having a rounded corner portion to match with the hanging unit insertion hole 307.

The locking device casing 337 of the door locking unit 330 is integrally formed with a plurality of bolt fixing parts 332 for fixing the bolts passing through the bolt fastening mounting holes 308.

In addition, the door locking unit 330 further includes a socket part 334 for electrical connection with a connector (not shown) of the electric wire that is extending from the control unit 810. The socket part 334 is disposed at the bottom of the locking device casing 337 and has a socket hole open in the width direction of the locking device casing 337.

If the washing machine 10 becomes inoperable due to a power failure or a malfunction during use of the washing machine 10, a user or an operator disassembles the cabinet 100 from the washing machine 10.

In this case, the string member 335 may be exposed in the lateral direction of the front panel 400 and the cover 300 of FIG. 4. In this case, the operator (or the user) manually unlocks the door locking unit 330 by pulling the string member 335 downward. As a result, the door hanging unit 260 separates from the door locking unit 330 and thus the door 200 can be manually opened.

Hereinafter, means for preventing interference between the door 200 and the cover 300 will be described in detail.

The door 200 of the washing machine 10 includes a door inner frame 230 and a door outer frame 240 which are coupled to each other.

The door 200 has a circular disk shape that is elegant in appearance and can greatly reduce the weight of the door 200.

The door 200 has a shape in which the outer thickness of the door 200 is thin and the thickness of the door 200 is increased toward the central portion of the door 200, so that it may be very advantageous and/or pleasing in terms of design and weight.

In consideration of the fact that the installation space of the internal device related to the door 200 may be relatively limited for the design of the door 200, the present embodiment provides a means capable of preventing interference between the door 200 and the cover 300 while still including a device or unit related to the display 202 (see FIG. 4). This unit displays the open/close state of the door 200 as well as dislays the operational state of the washing machine 10, and reliably performs the opening and closing functionalities of the door 200 and also the locking operation of the door 200.

Referring to FIG. 10, the door glass 280 includes a glass edge portion 289 formed integrally with a cap-shaped glass body which protrudes toward the rear, e.g., toward the drum 600. Here, the glass edge portion 289 is bent at a right angle at the outer periphery of the glass body and extends or protrudes by a predetermined length to be interposed between an open center side edge 239 of the door inner frame 230 and an open center side edge 249 of the door outer frame 240.

The door inner frame 230 includes a door inclined plane 2320 on its outer surface. The door inclined plane 2320 may be formed continuously or partially along the circumferential direction of the door inner frame 230 with reference to the outer position of the door glass 280. For example, the door inclined plane 2320 is formed between the open center side edge 239 of the door inner frame 230 and an outer edge 238 of the door inner frame 230.

The door inclined plane 2320 and a cover inclined plane 3020 are inclined in the same direction such that they do not physically interfere with each other, and a gap may be formed between the surfaces facing to each other.

Referring to FIGS. 5 and 6, the door inclined plane 2320 includes a ring-shaped protrusion 2321 formed on the open center side of the door inner frame 230 such that it is parallel to the extending direction of the glass edge portion 289 of FIG. 10 mentioned above.

The ring-shaped protrusion 2321 is positioned on the outer surface of the door inner frame 230 to surround the door glass 280 and support the edge portion 289 of the door glass 280.

The door inclined plane 2320 is inclined forward by the predetermined inclination angle Q with reference to the outer surface of the ring-shaped protrusion 2321. For example, the door inclined plane 2320 is inclined toward the door outer frame 240 between the ring-shaped protrusion 2321 and the outer edge 238 of the door inner frame 230.

A groove or a recess 2322 for accommodating the detergent container handle 502 is formed on the door inclined plane 2320 so that the door 200 and the detergent container handle 502 of the detergent container 500 shown in FIG. 4 do not physically interfere with each other when the door 200 is closed.

The cover 300 includes a gap holding portion 3010 that is integrally formed on the lower outer surface of the cover 300 to prevent interference between the lower outer surface of the door inner frame 230 and the lower outer surface of the cover 300 which face each other.

The recessed space size of the gap holding portion 3010 may be designed within a range that can accommodate a circuit protection portion 2310 in a non-contacting manner.

The gap holding portion 3010 prevents contact with the circuit protection portion 2310 of the door 200 when the door 200 is closed.

The circuit protection portion 2310 serves to provide a space for installing component parts provided inside the door 200 and to secure the safety of the electric parts while guaranteeing the life of the product. Furthermore, the circuit protection portion 2310 prevents electrical accidents, such as a short circuit. For example, the circuit protection portion 2310 protects a display circuit to be mounted in the circuit receiving portion 2410.

Since the circuit protection portion 2310 is not in contact with the gap holding portion 3010, any physical impact on the cover 300 that can occur when the door 200 is opened and closed will not be directly applied to the circuit protection portion 2310 through the gap holding portion 3010. Therefore, it is possible, in this fashion, to protect the display circuit from physical shock.

The gap holding portion 3010 is formed on the door inner frame 230 based on a location corresponding to the circuit protection portion 2310 and further to be recessed toward the front panel 400. That is, the gap holding portion 3010 is designed such that it can avoid or escape from the circuit protection portion 2310 which faces the gap holding portion 3010 or corresponds in a non-contacting manner to the gap holding portion 3010.

It can be understood that the recessed state of the unit mounting portion 3050 and the gap holding portion 3010 has a relatively lower level than the cover inclined plane 3020. For this purpose, the gap holding portion 3010 has a position, area and shape that can be engaged in a non-contacting manner with the circuit protection portion 2310 such that they do not interfere with each other in correspondence with the position, area and shape of the circuit protection portion 2310.

For example, the gap holding portion 3010 is recessed toward the front panel 400, and the recessed shape may reduce or prevent any operational interference with the door 200. In addition, the recessed shape of the gap holding portion 3010 essentially blocks any impact transmission due to such contact, thereby enhancing the product durability of the door 200 and the door-related components, and preventing unwanted noise from being generated.

Therefore, when the door of the washing machine 10 is closed (e.g., in a state where the door glass 280 of the door 200 is in close contact with the door gasket 450 of the front panel 400 when the door 200 is rotated toward the cover), the circuit protection portion 2310 is separated from the gap holding portion 3010 of the lower outer surface of the cover 300 by a gap G (see FIG. 10).

In addition, the cover 300 includes the unit mounting portion 3050 integrally formed with the intermediate outer surface of the cover 300.

The recessed space size of the unit mounting portion 3050 may be designed within a range that can accommodate a door locking support portion 2350 in a non-contacting manner.

The unit mounting portion 3050 serves to prevent interference between the intermediate outer surface of the door inner frame 230 and the intermediate outer surface of the cover 300 which face each other with reference to the installation position of the door hanging unit 260 or the position corresponding to the door locking support portion 2350.

The unit mounting portion 3050 also serves to prevent contact with the door locking support portion 2350 when the door 200 is closed. The unit mounting portion 3050 is also recessed toward the front panel 400.

The door hanging unit 260 includes a protruding portion 261, e.g., latch protruding toward the door locking unit 330, and a base portion 262 formed integrally at the ends facing the door 200 to have a T-shaped cross section. The base portion 262 is formed with holes so that the installation is possible by bolts or screws. In addition, since an installation guide groove 263 (penetrating the base portion 262 in the thickness direction) is formed at the edge of the base portion 262, the door hanging unit 260 can be installed accurately. To this end, an installation guide protrusion 2361 which is engaged in shape with the installation guide groove 263 is formed on the inner side surface of an installation groove portion 2360 of the door locking support portion 2350 of the door inner frame 230.

The door glass 280 is supported on the open center side edge 239 of the door inner frame 230.

The protective glass 204 is provided on the front surface of the door outer frame 240 and closes the center opening of the door outer frame 240.

The door outer frame 240 is provided with the circuit receiving portion 2410 with respect to a lower position of the center opening of the door outer frame 240.

The circuit receiving portion 2410 protrudes from the inner surface of the door outer frame 240 toward the door inner frame 230 and serves to receive a display circuit (not shown) for the display 202.

The circuit receiving portion 2410 includes a wall body 2411 and screw supports 2412.

The wall body 2411 protrudes from the inner surface of the door outer frame 240 in correspondence with the outer side of the circuit in order to accommodate the display circuit and is open in the front-rear direction in order to mount the display circuit.

The screw supports 2412 are disposed on both sides of the wall body 2411 and integrally formed on the inner surface of the door outer frame 240. The screw supports 2412 are used for screw or bolt connection between the door outer frame 240 and the door inner frame 230.

The front surface of the circuit receiving portion 2410 may be covered with the protective glass 204 and the rear surface of the circuit receiving portion 2410 may be covered with the circuit protection portion 2310 of the door inner frame 230 to be described later.

Since the circuit receiving portion 2410 is surrounded by the wall body 2411 and completed by the protective glass 204 or the circuit protection portion 2310, moisture or water droplets are prevented from flowing into the circuit receiving portion 2410.

The circuit protection portion 2310 is integrally formed with the door inner frame 230 in correspondence with the shape of the circuit receiving portion 2410 to cover the rear surface of the circuit receiving portion 2410.

For example, the circuit protection portion 2310 shown in FIG. 5 protrudes from the lower outer surface of the door inner frame 230 toward the cover 300 shown in FIG. 7, e.g., toward the gap holding portion 3010 of the cover 300 within a range that cannot contact with each other.

The lower outer surface of the door inner frame 230 on which the circuit protection portion 2310 is formed and the door inclined plane 2320 are integrally connected and the surface shape of the connected portion may be continuous.

The circuit protection portion 2310 includes a plurality of screw holes 2311 formed in the circuit protection portion 2310 for fastening screws corresponding to the screw supports 2412 of the circuit receiving portion 2410. Here, the screws may be fastened to the screw supports 2412 through the screw holes 2311 as a means for fixing the door inner frame 230 and the door outer frame 230 which are combined to each other in this fashion.

When the screws are fastened, in order to prevent interference between the door 200 and the cover 300 due to the screws, the head portions of the screws are not allowed to protrude from the screw holes 2311 toward the outer surface of the circuit protection portion 2310. For this purpose, head seating grooves 2312 of the screws are formed at the ends of the screw holes 2311.

Referring to FIGS. 7 and 8, the cover 300 includes the cover inclined plane 3020 formed between the laundry inlet 302 formed on the cover 300 and the outer rim 3024 of the cover 300 to maintain, as shown in FIG. 10, a non-contact gap (the gap G) with respect to the outer surface of the door inner frame 230.

The cover inclined plane 3020 extends along the circumferential direction of the cover 300.

More specifically, the cover inclined plane 3020 includes a lower inclined plane 3021 extending in the radial direction of the cover from the laundry inlet 302 to maintain a gap with respect to the ring-shaped protrusion 2321 of the door inner frame 230.

The cover inclined plane 3020 also includes an upper inclined plane 3022 which is integrally formed with the outer edge of the lower inclined plane 3021 and extends at a relatively larger inclination angle than the lower inclined plane 3021.

The cover inclined plane 302 further includes a channel portion 3023 which is integrally formed with the outer edge of the upper inclined plane 3022 and is coupled with the cover connection unit 104 of the cabinet 100.

The channel portion 3023 may extend along the circumferential direction of the cover 300 or extend along the outer rim of the cover 300 corresponding to the cover connection unit 104. The cover connection unit 104 of the cabinet 100 is fitted to the channel portion 3023.

The channel portion 3023 may prevent fluid infiltration and may also discharge any fluid.

When the channel portion 3023 and the cover connection unit 104 are fitted to each other, a U-shaped trap-like gap is formed between the surface of the channel portion 3023 and the surface of the cover connection unit 104. Therefore, external moisture or water droplets between the channel portion 3023 and the cover connection unit 104 are substantially prevented from penetrating into the internal space of the cabinet 100 through the U-shaped, trap-like, gap.

In addition, since the channel portion 3023 which forms the U-shaped, trap-like, gap is open only in the direction of gravity, the channel portion 3023 also plays a role of discharging water droplets naturally by gravity.

For example, the cover 300 includes an extension plate 3030 protruding downward from the cover 300 in order to install the power processing unit 306 (see FIG. 4) at the periphery of the channel portion 3023 adjacent to the gap holding portion 3010.

Water discharge passageways 3031 are formed on both sides of the extension plate 3030. A passageway connecting portion 3032 is formed between the upper end of each water discharge passageway 3031 and the channel portion 3023 and functions to allow mutual flow of the fluid therethrough. The lower ends of the respective water discharge passageways 3031 are opened downward.

Therefore, water, moisture or water drops generated when cleaning the washing machine 10 can be advantageously discharged through the lower ends of the water discharge passageways 3031.

Referring to FIGS. 7 and 9, the gap holding portion 3010 of the cover 300 has a symmetrical shape with respect to a center line CL connecting the upper end and the lower end of the cover 300.

On the outer surface of the gap holding portion 3010, there is formed a transition portion 3011 for a shape-connection between the gap holding portion 3010 and the cover inclined plane 3020.

The transition portion 3011 serves to increase the external design of the cover 300 and to disperse any externally applied impact load.

In this way, the gap holding portion 3010 is formed in a recessed shape on the cover 300. Accordingly, the gap holding portion 3010 is not in contact with the circuit protection portion 2310 which is extended toward the cover 300 from the lower outer side surface of the door inner frame 230 described in detail above.

Even if the door glass 280 of the door 200 touches the door gasket 450 of the cover 300, the gap holding portion 3010 of the cover 300 provides the gap G that does not allow the gap holding portion 3010 to make contact with the circuit protection portion 2310 of the door 200. Since the gap G may numerically vary depending on the coupling tolerance, the partial shape or the like and the numerical value of the gap G may not be limited to a specific value.

The transition portion 3011 in the gap holding portion 3010 may be a boundary point of the lower inclined plane 3021 formed in the door inner frame 230. Therefore, the transition portion 3011 may be included in the configuration of the gap holding portion 3010.

The gap holding portion 3010 includes a bottom portion 3012 extending from the transition portion 3011 in the outward direction of the cover 300.

The gap holding portion 3010 further includes a first corner portion 3013 and a first curved surface portion 3014 that serves as a fluid flow bump so that water does not directly reach the power button hole 3033 on which the power button 102 is installed.

Since the first curved surface portion 3014 is at least a corrugated wall body positioned higher than the bottom portion 3012, or the channel portion 3023, when the cover 300 is assembled in a vertically erected state as shown in FIG. 7, water drops cannot penetrate directly toward the power button hole 3033.

For this purpose, the first corner portion 3013 is bent in an upwardly inclined direction from the outer edge of the bottom portion 3012 of the gap holding portion 3010.

The first curved surface portion 3014 extends from the outer edge of the first corner portion 3013 to the channel portion 3023 of the outer rim of the cover 300.

Further, the bottom portion 3012 of the gap holding portion 3010 in in a relatively low level compared with the channel portion 3023. Therefore, even if water reaches the bottom portion 3012, the water moves to the first curved surface portion 3014 along the curved surface of the first corner portion 3013 and then falls. Otherwise, even if the water goes over the first curved surface portion 3014 to reach the channel portion 3023, the water is discharged downward through the channel portion 3023, the passageway connecting portion 3032 and the water discharge passageways 3031 which are penetrably connected to each other, and may not flow toward the power button hole 3033.

A ring-shaped bump 3034 for preventing water penetration is formed at the end of the power button hole 3033.

Referring to FIGS. 5, 7 and 11, the door 200 includes a door locking support portion 2350 which serves as an installation base for the door hanging unit 260 and is formed to protrude from the intermediate outer side surface of the door inner frame 230 toward the cover 300 to secure an installation space of the door opening button circuit module 2100. For example, the door locking support portion 2350 is integrally connected to the door inclined plane 2320 and disposed at a position opposite to the door hinge 360.

The door 200 includes a unit mounting portion 3050 which is depressed toward the front panel 400 to avoid contact with the door locking support portion 2350.

Therefore, when the door of the washing machine 10 is closed, the door locking support portion 2350 may maintain a clearance with respect to the unit mounting portion 3050.

The hanging unit insertion hole 307 is formed in the thickness direction of the unit mounting portion 3050. The bolt fastening mounting holes 308 are formed at the peripheral positions of the hanging unit insertion hole 307.

The door locking support portion 2350 includes the installation groove portion 2360 in which a base part 262 of the door hanging unit 260 is seated, and the stem through hole 233 through which the stem 2540 of the door opening unit 250 is inserted. The installation groove portion 2360 is relatively depressed with respect to the outer surface of the door locking support portion 2350 with respect to a position corresponding to the hanging unit insertion hole 307. The stem through hole 233 is formed at a position spaced upward from the installation groove portion 2360.

With the same principle, the unit mounting portion 3050 is designed to be able to avoid or escape from the door locking support portion 2350 which faces the unit mounting portion 3050, therefore the door locking support portion does not contact the unit mounting portion 3050.

The door locking support portion 2350 includes a screw hole 2362 formed at a position spaced downward from the installation groove portion 2360. Here, the screw hole 2362 is formed in the door locking support portion 2350 to fasten a screw corresponding to the circuit housing 2110 of the door opening button circuit module 2100. The screw hole 2362 of the door locking support portion 2350 is formed in the same state as the screw hole 2311 of the circuit protection portion 2310 described above. That is, the screw hole 2362 of the door locking support portion 2350 also has a seating groove formed at the end of the screw hole 2362 so as not to project the head portion of the screw to the outer surface of the door locking support portion 2350.

The unit mounting portion 3050 has a relatively large surface area as compared with the door locking support portion 2350. For this reason, the unit mounting portion 3050 may not be brought into contact with the door locking support portion 2350 even if the clearance reached upon operation (e.g., rotation) of the door 200 is considered.

That is, the unit mounting portion 3050 also does not contact the door locking support portion 2350, so that it is possible to maintain a gap or a clearance of the same or similar size as the gap G of FIG. 10.

For this purpose, the unit mounting portion 3050 includes: a boundary portion 3051 formed between the outer edge of the lower inclined plane 3021 and the hanging unit insertion hole 307 in the cover 300; and a flat portion 3052 extending from the boundary portion 3051 toward the outer side of the cover 300 to be parallel to the door locking support portion 2350. Here, the hanging unit insertion hole 307 is formed in the thickness direction of the flat portion 3052.

The unit mounting portion 3050 further includes: a second corner portion 3053 which is bent in the upwardly inclined direction from the outer edge of the flat portion 3052; and a second curved surface portion 3054 extending from the outer edge of the second corner portion 3053 to the channel portion 3023 of the outer rim of the cover 300.

The second curved surface portion 3054 may be a corrugated wall body positioned higher than the flat portion 3052 or the channel portion 3023, and may be a portion extending from the first curved surface portion 3014 mentioned above. Further, the flat portion 3052 has a relatively lower level than the channel portion 3023.

The door locking unit 330 is installed on the base of the rear surface of the flat portion 3052 of the unit mounting portion 3050. Here, the rear surface of the flat portion 3052 is parallel to the surface of the locking device casing 337 of the door locking unit 330. In addition, the hanging unit inlet port 331 of the door locking unit 330 and the hanging unit insertion hole 307 of the flat portion 3052 may match with each other.

In this case, the door locking unit 330 can be in surface-to-surface contact with the rear surface of the flat portion 3052 to maintain a solid installation state, and the locking engagement between the door hanging unit 260 and the door locking unit 330 can be performed smoothly.

As described above, the wall mounted washing machine and its cover, in accordance with the embodiments of the disclosure, have an advantage in that an additional handle for opening and closing a door can be removed.

In addition, the locking release state of the door locking unit and the opening action of the door may be easily performed by merely activating the door opening button, thereby increasing user convenience in door opening and closing actions.

In addition, there is an advantage in that the door may be easily opened with an electronic opening and closing type in accordance with embodiments of the present invention.

In addition, there is an advantage in that the door may be opened and closed by a door opening unit protruding when the locking state of the door is released.

In addition, there is an advantage in that the door may be opened quickly by utilizing both an elastic force stored in the door opening unit and an elastic force of a door gasket.

In addition, there is an advantage in that the door may be opened by manually releasing a lock of the door locking unit when the power fails or the control unit fails.

Further, the door is implemented herein in such a way that it does not interfere with other components in operation thereof, so that operating noise is reduced and impacts caused by component contact are prevented in advance, thereby increasing the life of the machine.

The above description is merely illustrative of the technical idea of the present disclosure and various changes and modifications may be made without departing from the essential characteristics of the present disclosure. Therefore, the embodiments described in the present disclosure are not intended to limit the scope of the present disclosure, but are intended to illustrate and not limit the scope of the present disclosure. The scope of protection of the present disclosure should be construed according to the following claims, and all technical ideas which are equivalent or equivalent thereto should be interpreted as being included in the scope of the present disclosure.

What is claimed is:

1. A wall mounted washing machine comprising:
a cabinet having a front surface and a rear surface;
a tub disposed in the cabinet and operable to contain wash water;
a front panel disposed in the tub;
a drum rotatably installed in the tub;
a cover disposed in the front panel and comprising a door hinge; and
a door rotatably coupled to the door hinge and comprising a door inner frame and a door outer frame which are coupled to each other, and
wherein the cover comprises:
a gap holding portion integrally formed on a lower outer surface of the cover and operable to prevent physical interference between a lower outer surface of the door inner frame and a lower outer surface of the cover which face each other.

2. The wall mounted washing machine according to claim 1, wherein the door further comprises:
a door glass supported by an open center side edge of the door inner frame;
a protective glass disposed on a front surface of the door outer frame within a center opening of the door outer frame;
a circuit receiving portion protruding from an inner surface of the door outer frame toward the door inner frame with respect to a lower position of the center opening and wherein said circuit receiving portion accommodates a display circuit; and
a circuit protection portion integrally formed on the door inner frame to protrude from a lower outer surface of the door inner frame toward the cover, and shaped to correspond with a shape of the circuit receiving portion, and
wherein the circuit protection portion of the door maintains a gap with respect to the gap holding portion of the cover when the door is closed.

3. The wall mounted washing machine according to claim 2, wherein the gap holding portion is recessed toward the front panel.

4. The wall mounted washing machine according to claim 3, wherein the circuit receiving portion comprises:
a wall body that protrudes from an inner surface of the door outer frame in correspondence with an outer side of the display circuit and is open in a front-rear direction to accommodate the display circuit; and
a screw support disposed on both sides of the wall body and integrally formed on the inner surface of the door outer frame.

5. The wall mounted washing machine according to claim 4, wherein the circuit protection portion comprises a screw hole formed in the circuit protection portion and operable to fasten a screw corresponding to the screw support.

6. The wall mounted washing machine according to claim 5, wherein the screw hole of the circuit protection portion has a seating groove formed at an end thereof and is operable to project a head portion of the screw to an outer surface of the circuit protection portion.

7. The wall mounted washing machine according to claim 2, wherein an outer surface of the door inner frame comprises a ring-shaped protrusion operable to support an edge portion of the door glass.

8. The wall mounted washing machine according to claim 7, wherein the cover comprises:
a cover inclined plane formed between a laundry inlet of the cover and an outer rim of the cover to not contact an outer surface of the door inner frame, and wherein the cover inclined plane extends along a circumferential direction of the cover.

9. The wall mounted washing machine according to claim 8, wherein the cover inclined plane comprises:
a lower inclined plane extending in a radial direction of the cover from the laundry inlet and operable to maintain a gap with respect to the ring-shaped protrusion of the door inner frame;
an upper inclined plane integrally formed with an outer edge of the lower inclined plane and extending at a relatively larger inclination angle than the lower inclined plane; and
a channel portion integrally formed with an outer edge of the upper inclined plane and coupled with a cover connection unit of the cabinet.

10. A washing machine comprising:
a cabinet;
a tub disposed in the cabinet and operable to contain wash water;
a front panel disposed in the tub;
a cover disposed in the front panel; and
a door rotatably coupled to the cover and comprising: a door inner frame; and a door inclined plane disposed between an open center side edge of the door inner frame and an outer edge of the door inner frame,
wherein the door further comprises a circuit protection portion protruding toward the cover from a lower outer surface of the door inner frame and is integrally coupled to the door inclined plane.

11. The washing machine according to claim 10, wherein the cover comprises:
a laundry inlet;
an outer rim;
a gap holding portion disposed at a position corresponding to the circuit protection portion and recessed toward the front panel, and wherein the gap holding portion operable to prevent contact with the circuit protection portion when the door is closed; and
a cover inclined plane formed between the laundry inlet and the outer rim and operable to not contact an outer surface of the door inner frame.

12. The washing machine according to claim 11, wherein the gap holding portion has a symmetrical shape with respect to a center line connecting upper and lower ends of the cover.

13. The washing machine according to claim 12, wherein a transition portion for a shape-connection between the gap holding portion and the cover inclined plane is formed on an outer surface of the gap holding portion.

14. A cover for a wall mounted washing machine, the wall mounted washing machine comprising a cabinet, a tub disposed in the cabinet, the tub operable to contain wash water; a front panel installed in the tub; a cover installed in the front panel and having a door hinge; and a door rotatably coupled to the door hinge and having a door inner frame and a door outer frame coupled to each other, the cover comprising:
a gap holding portion that is formed in a recessed shape on the cover to not contact a circuit protection portion protruding from a lower outer surface of the door inner frame toward the cover.

15. The cover of a wall mounted washing machine according to claim 14, further comprising:
a laundry inlet;
an outer rim; and
a cover inclined plane formed between the laundry inlet and the outer rim, the cover inclined plane operable to prevent interference with a door inclined plane of an outer surface of the door inner frame, wherein the cover inclined plane extending along a circumferential direction of the cover.

16. The cover of a wall mounted washing machine according to claim 15, wherein the door comprises a door gasket and a door glass and wherein further the gap holding portion comprises a gap that prevents contact with the circuit protection portion of the door even if the door glass touches the door gasket.

17. The cover of a wall mounted washing machine according to claim 16, wherein the gap holding portion comprises:
a transition portion that comprises a boundary point of a lower inclined plane formed in the door inner frame;
a bottom portion extending from the transition portion in an outward direction of the cover;
a first corner portion bent in an upwardly inclined direction from an outer edge of the bottom portion; and
a first curved surface portion extending from an outer edge of the first corner portion to a channel portion of the outer rim.

18. The cover of a wall mounted washing machine according to claim 17, wherein the bottom portion is disposed in a relatively low level as compared with the channel portion.

19. The cover of a wall mounted washing machine according to claim 18, further comprising:
an extension plate protruding downward from the cover and operable for installation of a power processing unit at a periphery of the channel portion adjacent to the gap holding portion; and
a water discharge passageway formed on both sides of the extension plate, and
wherein a passageway connecting portion is formed between an upper end of the water discharge passageway and the channel portion and operable to allow mutual fluid flow therethrough.
